(19) United States
(12) Patent Application Publication
(10) Pub. No.: US 2021/0027348 A1
(43) Pub. Date: Jan. 28, 2021

(54) Method for the Organizing and Provision of Student Sourced Services

(71) Applicant: Rishi Sadagopan, Pearland, TX (US)

(72) Inventor: Rishi Sadagopan, Pearland, TX (US)

(21) Appl. No.: 16/857,038

(22) Filed: Apr. 23, 2020

Related U.S. Application Data
(60) Provisional application No. 62/877,384, filed on Jul. 23, 2019.

(51) Int. Cl. G06Q 30/06; G06Q 50/00; G06Q 20/12; G06Q 10/06; G06Q 30/08; G06Q 10/08; G06Q 50/30; G06Q 30/02; H04W 4/50; H04W 4/02

(52) U.S. Cl. CPC G06Q 30/0605; G06Q 50/01; G06Q 30/0611; G06Q 20/127; G06Q 10/063112; H04W 4/02; G06Q 10/08345; G06Q 50/30; G06Q 30/0206; G06Q 30/0623; H04W 4/50; G06Q 30/08

(57) ABSTRACT

A method for organizing the provision of a services via a mobile application, in which the users of the application must be a current student with an active .edu email address. The method includes the creation of an account, in which the account may simultaneously be a customer account and a provider account, with the ability to switch instantly between the two forms within the application. Such services the application facilitates the provision of are generally focused towards activities commonly done by students currently at college, but they also include more general services, and the ability of students to advertise they are going for food, allowing them to collect additional orders for other application users, reducing the cost of their own meal or making a profit of said trip.

### CROSS-REFERENCE TO RELATED APPLICATIONS

This application claims benefit, including priority, of U.S. Provisional Patent Application Ser. No. 62/877,384, filed on Jul. 23, 2019, and titled A METHOD FOR THE ORGANISING AND PROVISION OF STUDENT SOURCED SERVICES, the entire contents of which are incorporated herein by this reference.

### FIELD

Embodiments described herein relate generally to the provision of services utilizing a platform, downloaded by users off various application marketplaces, to organize the provision of such services. More specifically, they relate to methods for connecting students with other students on the same college campus in order for one student to perform general tasks for the other student, at a price generally determined by the service requesting student.

### BACKGROUND

The present invention relates to the field of data communications in general and more specifically to a services sharing mobile application environment.

As reflected in the patent literature, there are a variety of mobile and computer applications that enable the user to crowd source a workforce for the competition of particular activities. Such applications generally operate on a principle in which the user advertises a specific task with a predetermined payment, set by an application administrator, for completion of said task. The service provider would then use the same application to view the potential work opportunity and the payment for completion and can either accept or reject the work offer. The service provider then travels to the user, performs the particular task, and receives a payment through the application. However, the majority of these applications do not specify a pool in which the service providers are drawn from, and many of the apps are limited to specific tasks, such as ride matching.

Therefore, a need exists to create an application that draws service providers from a limited and reliable pool, with that pool being related to the user specifically. A further need is the ability for the service provider to advertise a price decided by them as opposed to the application, creating a service marketplace facilitating the exchange of services driven by customer generated prices.

### SUMMARY

Methods for the provision of services utilizing a platform, downloaded by users off various application marketplaces, to organize the provision of such services are provided in embodiments herein.

In one embodiment, generally, a method for provisioning services via a mobile application is provided which includes . . . .

One or more embodiments include the method of any preceding paragraph, wherein the . . . .

One or more embodiments include the method of any preceding paragraph, wherein the . . .

In one embodiment, generally, a method for offering services via a mobile application is provided which includes . . . .

One or more embodiments include the method of any preceding paragraph, wherein the . . .

In one embodiment, generally, a method for arranging carpooling services via a mobile application is provided which includes . . .

One or more embodiments include the method of any preceding paragraph, wherein the . . .

In one embodiment, generally, a method for facilitating a student-based marketplace via a mobile application is provided which includes . . .

One or more embodiments include the method of any preceding paragraph, wherein the . . .

In one embodiment, generally, a method for facilitating the connection of individuals to allow for the provisioning of subject and talent specific tasks via a mobile application is provided which includes . . .

One or more embodiments include the method of any preceding paragraph, wherein the . . .

### BRIEF DESCRIPTION OF DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 illustrates a flow diagram illustrating example operations for provisioning services via a mobile application, in accordance with certain aspects of the present disclosure.

FIG. 2 illustrates a flow diagram illustrating example operations for offering services via a mobile application, in accordance with certain aspects of the present disclosure.

FIG. 3 illustrates a flow diagram illustrating example operations for arranging carpooling services via a mobile application, in accordance with certain aspects of the present disclosure.

FIG. 4 illustrates a flow diagram illustrating example operations for facilitating a student-based marketplace via mobile application, in accordance with certain aspects of the present disclosure.

FIG. 5 illustrates a flow diagram illustrating example operations for facilitating the connection of individuals to allow for the provisioning of subject and talent specific tasks via a mobile application, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

The following description provides example methods for the organising and provision of student sourced services, and is not limiting of the scope, applicability, or examples of elements discussed without departing from the scope, applicability, or examples of elements discussed without departing from the scope of the disclosure. Various examples may omit, substitute, or add various procedures or components as appropriate. It should be understood that any aspect of the disclosure disclosed herein may be embodied by one or more elements of a claim. The word “Exemplary” is used herein to mean “serving as an example, instance, or illustration” of any aspect as preferred or advantageous over other aspects

In general, aspects of the present disclosure provide methods for the organising and provision of student sourced services.

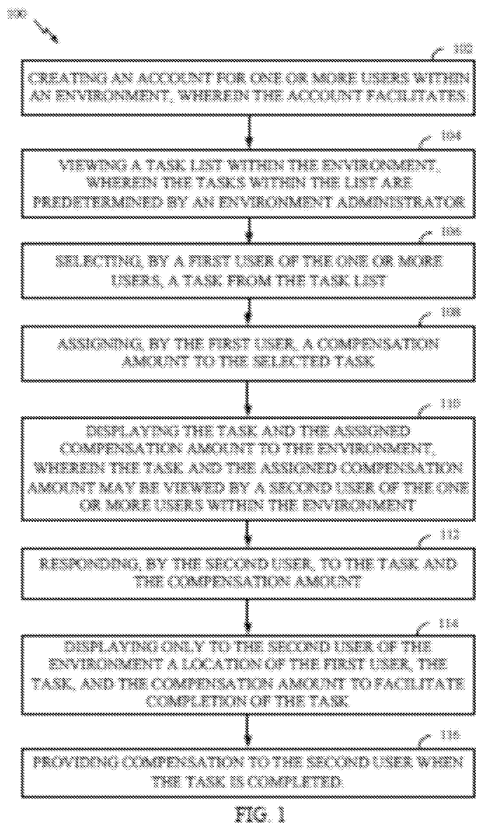

FIG. 1 is a flow diagram illustrating example operations 100 for provisioning services via a mobile application.

The operations 100 may begin at 102, by creating an account for one or more users within an environment, wherein the account facilitates further operations.

At 104, operations further include viewing a task list within the environment, wherein the tasks within the list are predetermined by an environment administrator.

At 106, operations further include selecting, by a first user of the one or more users, a task from the task list.

At 108, operations further include assigning, by the first user, a compensation amount to the selected task.

At 110, operations further include displaying the task and the assigned compensation amount to the environment, wherein the task and the assigned compensation amount may be viewed by a second user of the one or more users within the environment.

At 112, operations further include responding, by the second user to the task and the compensation amount.

At 114, operations further include displaying only to the second user of the environment a location of the first user, the task, and the compensation amount to facilitate completion of the task.

At 116, operations further include providing compensation to the second user when the task is completed.

Each user of the mobile application is required to create an account within the environment to enable use of the services provided. Each user within a multitude of users is either identified as a “provider”, a “customer”, or the account may simultaneously be both a “customer” account and a “provider” account. The “customer” account is for the requesting of services within the application, and the “provider” account is for offering the provision of such services.

To qualify as a “provider” within the environment, the individual must have an active and valid “.edu” email address to create an account, demonstrating that they are a current student. By creating an account, ultimately a “provider” is acknowledging and assuring they are a current student of a university. Establishing criteria required to qualify for “provider” status helps create a safer environment, specifically one in which only students may perform services for an unknown individual. However, ultimately, limiting “provider” users to current students helps students find quick jobs, build their resume before entering the workforce full-time, build rapport with the younger generation, and allow students to make money while they are going to school to better themselves and their education.

A user with “customer” status must be an individual who resides within a certain radius of a University where “provider” users attend school. The limited radius ensures that students will not have to travel far to complete a task for a “customer” and also helps to ensure the safety of “provider” users on the application. A user must often be within a 40-mile radius to qualify as a “customer” with the ability to request tasks.

After a user's account is created, it is stored within a centralized database. The central database stores information such as the user's general location, the user's place of current education, the user's telephone number, and other necessary contact information. The information stored in the centralized database is drawn upon during certain applications performed within the mobile application.

Embodiments of the present invention may include computer-implemented methods for matching users with “customer” status and users with “provider” status who reside within a certain radius of a University. Embodiments of the invention may include the creation of one of two types of accounts that will experience the mobile environment differently depending on the type of account selected. With the creation of a customer account, the customer user may select a task from a list of tasks determined by the environment administrator. This predefined task list appears within the application environment and may be viewed by the customer user, and, once selected, the customer user can set compensation for the provision of such task. The task, the compensation amount, and the customer user's location are bundled into a final task which is transmitted to a central database operated by the environment administrator via the application environment.

The customer user may alternatively assign the task to a bidding environment. To access the bidding environment, the customer user must select a time period for which the bidding environment will hold bidding open. The bidding environment allows provider users to enter incremental bids not less than the minimum bid amount predetermined by the environment administrator. The bidding environment will display the bids to the customer user as bids are entered by provider users in a sequential list. At the end of the time period, the bidding environment will close off the task to further bidding and select the final, highest bid from the list of bids. The bidding environment will assign the final bid to the customer user's task with the final bid's compensation amount. The task, the compensation amount, and the customer user's location are bundled into a final task which is transmitted to a central database operated by the environment administrator via the application environment.

Once this information is transmitted to the centralized database, an environment algorithm will use the geographic information of the customer to calculate nearby application users with a provider account. There are a plurality of mobile device location techniques that the algorithm may include. Locating other users in the environment may be based solely on wireless network signals from other users' mobile devices, Global Positioning System (GPS) based approaches, and assisted GPS approaches combining communication signals and GPS signals. Finally, the environment algorithm will generate a list of potential provider users and send out a task notification only to listed provider users.

Provider users who receive a task notification will have the option to offer to perform the task requested by the customer user based on the information provided by the customer user. If the customer user accepts the provider user's offer, the interaction will be transmitted to the central database, which will facilitate the display of the customer user's location to the provider user. Likewise, the customer user will receive information about the provider user.

Alternatively, in the bidding environment, the mechanics of acceptance differ. A customer user who assigns a selected task to a bidding environment must accept the final bid and cannot decline to accept the final bid. Likewise, the provider user whose final bid is selected by the bidding environment cannot change the bid or otherwise renegotiate the scope of the task or the compensation and must complete the task according to the terms of the customer user.

The provider user may be provided the necessary identification, for example, by establishing a voice connection and/or setting up a text messaging connection between the customer user so they may negotiate a payment or other agreement for the task, as well as providing the details necessary to facilitate completion of the task.

Once the task is completed the provider user will indicate this within the application environment. This will be transmitted to the central database where a notification will then be sent to the customer user confirming completion of the task. Once this completion has been acknowledged by both the customer and the provider, the application will release the compensation to the provider user's connected account.

FIG. 1 is a flow diagram illustrating example operations 100 for a method for organizing the provision of services from a predetermined group.

The operations 100 allow for a user, via a mobile application, at 102 to create an account within an environment.

At 104, the user may view a task list within the environment, the task list being predetermined by an environment administrator.

At 106, a user may create a task request from the task list.

At 108, the user may assign a level of compensation for the task.

At 110, this task request will be finalized and transmitted via the mobile network to the centralized database of the environment administrator. The centralized database then sorts through accounts to determine other application users within the general area, or at the same educational institute. Once identified, the application will post a notification to users who have created a provider account within the same general area as the requesting user. The notification will outline the task requested and the compensation offered.

At 112, a second user will be able to offer to provide services. Once an offer has been given for the task within the environment on the provider's mobile device, this offer will be transmitted to the centralized database and re-transmitted to the first user's mobile device. The database will then allow the requesting user the opportunity to review the provider's offer to perform services and accept such offer.

At 114, the second user will receive a notification from the environment that the offer has been accepted. The environment will then display the location of the first user, the task to be performed, and the compensation amount upon completion of the task.

At 116, once the finalized task has been completed, the first user will confirm completion through the application on a mobile device. This will be transmitted to the central database, which will then send notification to the second user, stating that the finalized task has been completed. The compensation will then be drawn from the first user's account through a linked credit card and will be paid into the connected bank account of the second user.

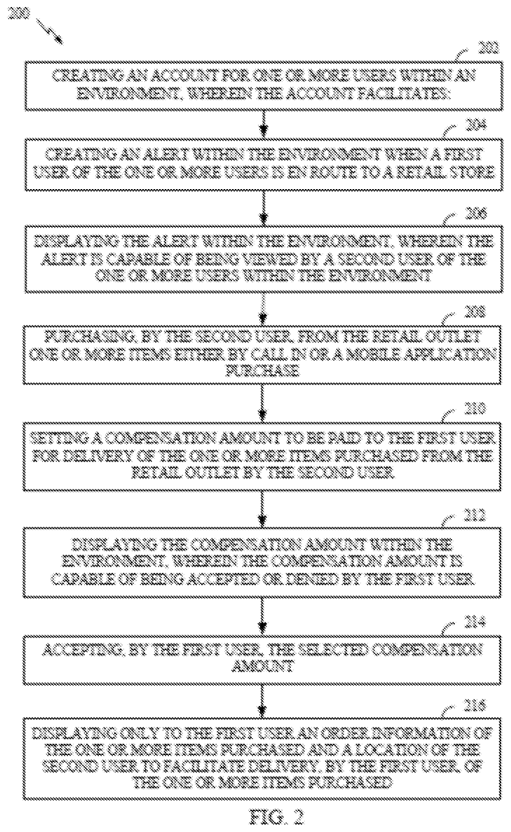

In a further embodiment of the operations 100, a user may create an “On-My-Way” notification. This information will be transmitted to the centralized database via the network and will then be retransmitted to other users within the general area of the notification creating user. FIG. 2 is a flow diagram illustrating example operations 200 for offering services via a mobile application.

The operations 200 may begin at 202, by creating an account for one or more users within an environment, wherein the account facilitates further operations.

At 204, operations further include creating an alert within the environment when a first user of the one or more users is en route to a retail outlet.

At 206, operations further include displaying the alert within the environment, wherein the alert is capable of being viewed by a second user of the one or more users within the environment.

At 208, operations further include purchasing, by the second user, from the retail outlet one or more items either by call in or a mobile application purchase.

At 210, operations further include setting a compensation amount to be paid to the first user for delivery of the one or more items purchased from the retail outlet by the second user.

At 212, operations further include displaying the compensation amount within the environment, wherein the compensation amount is capable of being accepted or denied by the first user.

At 214, operations further include accepting, by the first user, the selected compensation amount.

At 216, operations further include displaying only to the first user an order information of the one or more items purchased and a location of the second user to facilitate delivery, by the first user, of the one or more items purchased.

The operations 200 allow for dynamic customer user and provider user interactions where customer users have a need to purchase from a retail outlet where a provider user may contemporaneously be located, and the customer user may enlist the provider user for delivery of the retail product for an agreed upon price between both users. The operations 200 utilize the same mechanics of compensation highlighted in the operations 100 of FIG. 1 for providing compensation once the task is completed 116.

In a further embodiment of the operations 200, a user may create an “On-My-Way” notification. If the user is generally going to a retail outlet, the user may create a notification within the application environment. This notification will include the proposed retail outlet, when the user will be going, the compensation they would expect for collecting an item, and the retail outlet's current location. This information will be transmitted to the centralized database via the network and will then be retransmitted to other users within the general area of the notification creating user. The users who receive the “On-My-Way” notification may then place an item pick-up request within the environment, indicating the item they would like delivered, and including payment for delivery of the item through the application environment. The delivery fee is predetermined by the environment administrator through fixed rates depending on distance travelled between users and gas prices. The user at the retail outlet will be shown the ordering user's location in order to enable delivery. Payment of the delivery fee is not transferred until the user receives the ordered item.

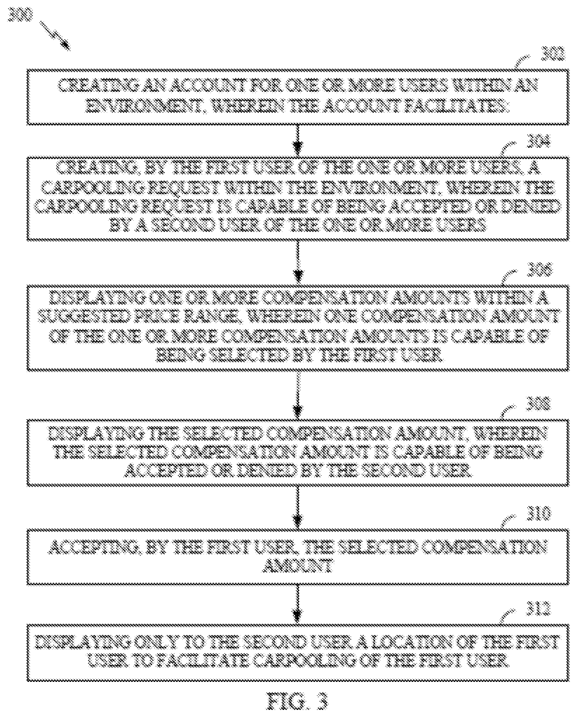

FIG. 3 is a flow diagram illustrating example operations 300 for arranging carpooling services via a mobile application.

The operations 300 may begin at 302, by creating an account for one or more users within an environment, wherein the account facilitates further operations.

At 304, operations further include creating, by the first user of the one or more users, a carpooling request within the environment, wherein the carpooling request is capable of being accepted or denied by a second user of the one or more users.

At 306, operations further include displaying one or more compensation amounts within a suggested price range, wherein one compensation amount of the one or more compensation amounts is capable of being selected by the first user.

At 308, operations further include displaying the selected compensation amount, wherein the selected compensation amount is capable of being accepted or denied by the second user.

At 310, operations further include accepting, by the second user, the selected compensation amount.

At 312, operations further include displaying only to the second user a location of the first user to facilitate carpooling of the first user.

Carpooling services allow users to find, connect, and carpool with other users going the same direction. Within this function, verified drivers (e.g., “providers”), who are registered students at a University, offer rides during their commute. Riders who are going the same way at the same time may choose to carpool with the driver for a single trip at a predetermined rate. Rates may be calculated on an IRS mileage rate basis. See https://www.irs.gov/pub/irs-drop/n-20-05.pdf.

The operations 300 allow for dynamic customer user and provider user interactions where customer users have a need for transportation services and provider users are currently en route to the customer users indicated destination. The operations 300 further facilitate efficient transportation planning by college students.

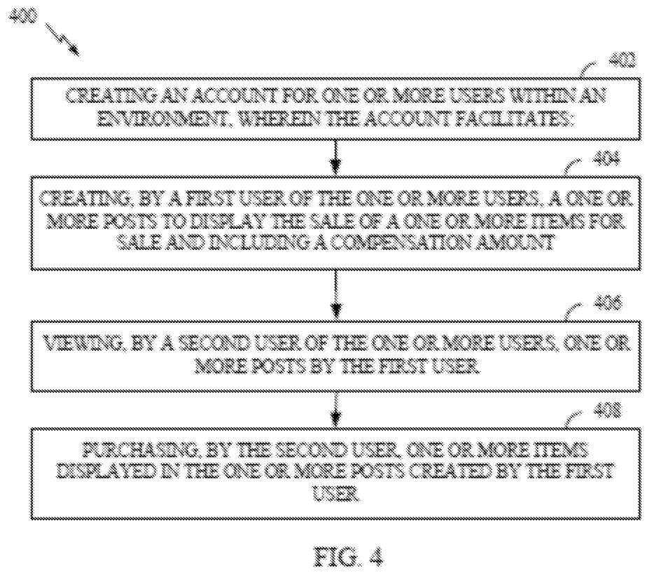

FIG. 4 is a flow diagram illustrating example operations 400 for facilitating a student-based marketplace via a mobile application.

The operations 400 may begin at 402, by creating an account for one or more users within an environment, wherein the account facilitates further operations.

At 404, operations further include creating, by a first user of the one or more users, a one or more posts to display the sale of a one or more items for sale and including a compensation amount.

At 406, operations further include viewing, by a second user of the one or more users, one or more posts by the first user.

At 408, operations further include purchasing, by the second user, one or more items displayed in the one or more posts created by the first user.

The operations 400 allow for customer user and provider user interactions where customer users have a need for specific goods or school related materials. The environment will further also allow for the exchange or trade for school materials and books.

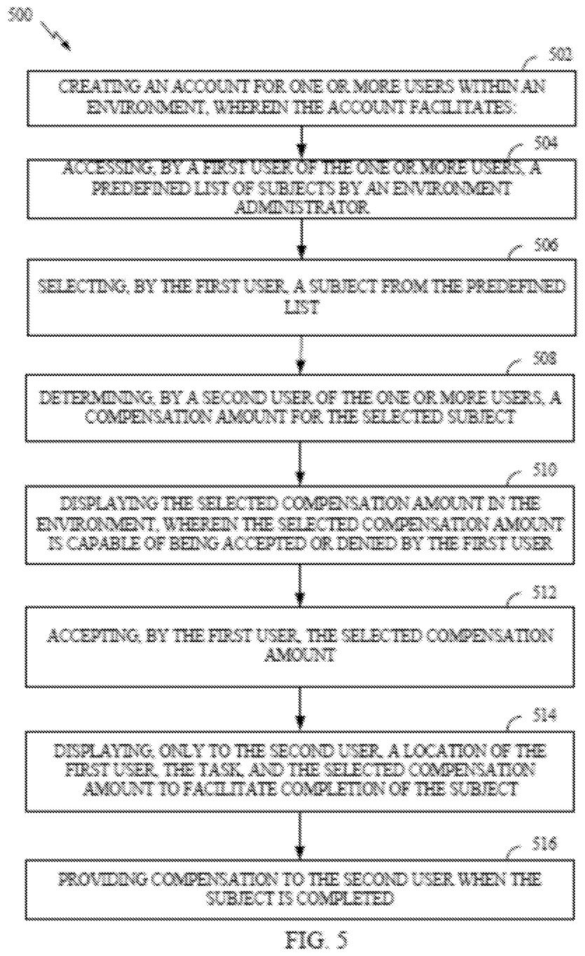

FIG. 5 is a flow diagram illustrating example operations 500 for facilitating the connection of individuals to allow for the provisioning of subject and talent specific tasks via a mobile application.

The operations 500 may begin at 502, by creating an account for one or more users within an environment, wherein the account facilitates further operations.

At 504, operations further include accessing, by a first user of the one or more users, a predefined list of subjects defined by an environment administrator.

At 506, operations further include selecting, by the first user, a subject from the predefined list.

At 508, operations further include determining, by a second user of the one or more users, a compensation amount for the selected subject.

At 510, operations further include displaying the selected compensation amount in the environment, wherein the selected compensation amount is capable of being accepted or denied by the first user.

At 512, operations further include accepting, by the first user, the selected compensation amount.

At 514, operations further include displaying, only to the second user, a location of the first user, the selected subject, and the selected compensation amount to facilitate completion of the subject.

At 516, operations further include providing compensation to the second user when the subject is completed.

The predefined list of subjects includes, but is not limited to, subjects such as photography, modelling, art, various hobbies, shopping and delivery, home repairs, cleaning, moving, and furniture assembly. The mobile application facilitates the request and acceptance of such services between a customer and a provider (e.g., college student), respectively. The mobile application helps to reduce any guilt and discomfort associated with hiring someone to do menial labor. Customers may get a quote and book a service within a provided subject without ever needing to talk on the phone or come into contact with the provider (e.g., college student) whom is performing the subject-specific service.

Although the subject matter has been described in language specific to operations, it is to be understood that the subject matter defined in the appended claims is not necessarily limited to operations described above. Rather, the specific features and acts described above are disclosed as example forms of implementing the claims. Further, it is to be understood that the subject matter may be implemented in a computer readable program instructions. As will be appreciated by one of skill in the art, the present invention may be embodied as a method, data processing system, and/or computer program product.

Accordingly, the present invention may take the form of an entirely hardware embodiment, an entirely software embodiment or an embodiment combining software and hardware aspects all generally referred to herein as a “circuit” or “module.” Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, Swift, Java®., C++ or the like, and conventional procedural programming languages, such as the “C” programming language or similar programming languages.

These computer readable program instructions may be provided to a processor of a general purpose computer, special purpose computer, or other programmable data processing apparatus to produce a machine, such that the instructions, which execute via the processor of the computer or other programmable data processing apparatus, implement the various methods and acts specified in the flowcharts provided. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the methods and acts specified in the flowcharts.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the methods and acts specified in the flowcharts.

The mobile software product may be downloaded from various online marketplaces, and may be stored on a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a magnetic storage device, or any suitable combination of the foregoing. A non-exhaustive list of more specific examples of the computer readable storage device includes the following: a portable computer diskette, a hard drive, a random access memory (RAM), a read-only memory (ROM), an erasable programmable read-only memory (EPROM or Flash memory) a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computer or processing devices from a computer readable storage medium or to an external computer or external storage device via a network, for example, an online marketplace, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for provisioning services via a mobile application comprising:
creating an account for one or more users within an environment, wherein the account facilitates:
viewing a task list within the environment, wherein the tasks within the list are predetermined by an environment administrator;
selecting, by a first user of the one or more users, a task from the task list;
assigning, by the first user, a compensation amount to the selected task;
displaying the task and the assigned compensation amount to the environment, wherein the task and the assigned compensation amount may be viewed by a second user of the one or more users within the environment;
responding, by the second user to the task and the compensation amount;
displaying only to the second user of the environment a location of the first user, the task, and the compensation amount to facilitate completion of the task; and
providing compensation to the second user when the task is completed.

2. The method of claim 1, wherein the account of the one or more users is limited to an account registered to a current college student residing in the United States with an active “.edu” email address.

3. The method of claim 2, wherein the account of the one or more users is limited to an account registered to a user within the community where the current college student resides.

4. The method of claim 1, wherein responding, by the second user of the one or more users includes accepting the task, declining the task, entering a counter-offer to be displayed to the first user, or entering a message to be sent to the first user.

5. The method of claim 1, wherein displaying only to the second user of the environment further includes a time constraint for performance of the task, wherein the time constraint is set by the first user.

6. The method of claim 1, wherein the environment is:
arranged to further gather, at the selection of a first user, characteristic information indicative of a selected task;
arranged to gather characteristic information indicative of the quality of a plurality of users capable of performing the selected task within the environment as input collectively by other users within the environment;
arranged to store user input information within the environment for on-demand viewing;
arranged to select at least one user within the environment with the capability to carry out the task by comparing the gathered first user capabilities information and the gathered task information; and
arranged to communicate the contact information of the second user to the first user.

7. The method of claim 6, wherein providing the contact information includes providing at least one of the first user and the second user identification information for use in visual identification of the other user.

8. The method of claim 1, further comprising:
assigning, by the first user, the task to a bidding environment;
selecting, by the first user, a time window, wherein the time window specifies the amount of time the bidding environment is open;
entering a bid, by at least one of the one or more users, within the time window;
displaying a list of bids from at least one of the one or more users to the first user, selecting, by the first user, a final bid from the list of bids; and
assigning the final bid to the compensation amount.

9. The method of claim 8, wherein the bids entered by at least one of the one or more users cannot be less than a minimum bid amount predetermined by an environment administrator.

10. A method for offering services via a mobile application comprising:
creating an account for one or more users within an environment, wherein the account facilitates:
creating an alert within the environment when a first user of the one or more users is en route to a retail outlet, wherein the account created for the first user is limited to an account registered to a current college student residing in the United States with an active “.edu” email address;
displaying the alert within the environment, wherein the alert is capable of being viewed by a second user of the one or more users within the environment;
purchasing, by the second user, from the retail outlet one or more items either by call in or a mobile application purchase;
setting a compensation amount to be paid to the first user for delivery of the one or more items purchased from the retail outlet by the second user;
displaying the compensation amount within the environment, wherein the compensation amount is capable of being accepted or denied by the first user;
accepting, by the first user, the selected compensation amount; and
displaying only to the first user an order information of the one or more items purchased and a location of the second user to facilitate delivery, by the first user, of the one or more items purchased.

11. The method of claim 10, wherein the account created for the first user is limited to an account registered to a current college student residing in the United States with an active “.edu” email address.

12. The method of claim 10, wherein the compensation amount is not less than $4 United States Dollars.

13. The method of claim 10, wherein the first user may arrange for carpooling services via the environment, comprising:
creating, by the first user of the one or more users, a carpooling request within the environment, wherein the carpooling request is capable of being accepted or denied by a second user of the one or more users;
displaying one or more compensation amounts within a suggested price range, wherein one compensation amount of the one or more compensation amounts is capable of being selected by the first user;
displaying the selected compensation amount, wherein the selected compensation amount is capable of being accepted or denied by the second user;
accepting, by the second user, the selected compensation amount;
displaying only to the second user a location of the first user to facilitate carpooling of the first user; and
notifying the first user that the second user is “On-My-Way”.

14. The method of claim 13, wherein the suggested price range is based on an IRS mileage rate.

15. The method of claim 10, wherein the first user may arrange a student-based marketplace via the environment, comprising:
creating, by a first user of the one or more users, a one or more posts to display the sale of a one or more items for sale and including a compensation amount;
viewing, by a second user of the one or more users, the one or more posts by the first user; and
purchasing, by the second user, the one or more items displayed in the one or more posts created by the first user.

16. The method of claim 15, wherein the one or more posts further include an uploadable image, a description of the one or more items, or combinations thereof.

17. The method of claim 15, wherein purchasing further includes accepting the compensation amount displayed in the one or more posts.

18. A method of facilitating the connection of individuals to allow for the provisioning of subject and talent specific tasks via a mobile application, comprising;
creating an account for one or more users within an environment, wherein the account facilitates:
accessing, by a first user of the one or more users, a predefined list of subjects defined by an environment administrator;
selecting, by the first user, a subject from the predefined list;
determining, by a second user of the one or more users, a compensation amount for the selected subject;
displaying the selected compensation amount in the environment, wherein the selected compensation amount is capable of being accepted or denied by the first user;
accepting, by the first user, the selected compensation amount; and
displaying, only to the second user, a location of the first user, the selected subject, and the selected compensation amount to facilitate completion of the subject; and
providing compensation to the second user when the subject is completed.

19. The method of claim 18, wherein the account created for the first user is limited to an account registered to a current college student residing in the United States with an active “.edu” email address.

20. The method of claim 18, wherein the predefined list of subjects includes but is not limited to a subject of photography, a subject of modelling, a subject of art, a subject of hobby, a subject of delivery/shopping, a subject of home repairs, a subject of cleaning, a subject of moving, and a subject of furniture assembly.

21. The method of claim 18, wherein displaying only to the second user of the environment further includes displaying a time limit for completion of the selected subject.
